(19) United States
(12) Patent Application Publication
(10) Pub. No.: US 2010/0256034 A1
(43) Pub. Date: Oct. 7, 2010

(54) COPPER CHELATING AGENT, COMPOSITION INCLUDING THE AGENT, AND METHODS OF FORMING AND USING THE AGENT AND COMPOSITION

(75) Inventor: Nael N. Zaki, Peoria, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: PANTHEON CHEMICAL, INC., Phoenix, AZ (US)

(21) Appl. No.: 11/534,183

(22) Filed: Sep. 21, 2006

Related U.S. Application Data
(60) Provisional application No. 60/719,501, filed on Sep. 22, 2005.

(51) Int. Cl. C11D 7/32

(52) U.S. Cl. 510/190

(57) ABSTRACT

A cleaning agent, a composition including the agent, and methods of forming and using the agent and composition are disclosed. The agent is formed by combining an organic acid and an amine in the presence in a base to form a compound for chelating copper ions. The composition optionally includes diluents, surfactants, sequestering agents, corrosion inhibitors and/or thickening agents.

### TECHNICAL FIELD

The present invention generally relates to chelating agents and cleaning compositions including the agents, and in particular the invention relates to copper chelating agents, compositions including the copper chelating agents and methods of using and forming the agents and compositions.

### BACKGROUND OF THE INVENTION

Firearms such as guns, cannons, and the like generally operate by forcing a projectile, such as a bullet, though a bore of the firearm by igniting a propellant such as gunpowder. When a firearm is discharged, residue, which often includes copper, from the projectiles forms on an interior portion of the bore. The presence of the copper deposits on the internal surface of the gun bore may cause galvanic corrosion. The galvanic corrosion refers to corrosion damage induced when two dissimilar materials are coupled in contact in the presence of moisture. Therefore, the removal of the deposited residue is important to maintenance and safety of operation of the firearm.

Historically, copper was removed from the firearm bore by using ammonium hydroxide solution. The common oxidation states of copper include the less stable copper (I) state, Cu⁺; and the more stable copper (II) state, Cu²⁺, which forms blue or blue-green salts and solutions. Ammonium hydroxide (ammonia) solution reacts with Cu²⁺ to form a deep blue ammonia complex, tetraaminecopper(II), according to the following ionic equation:

Cu²⁺(aq)+4NH₃(aq)→[Cu(NH₃)₄]²⁺(aq)

Although ammonia-based compositions work relatively well at removing copper debris, the use of ammonia-based compositions may be undesirable for several reasons. For example, at certain concentrations, ammonia becomes an irritant, and at higher concentrations, ammonia is toxic.

The odor threshold for ammonia is about 17 PPM, although the range of sensitivity ranges from 0.7 PPM to 50 PPM for acclimatized individuals. Concentrations of up to 25 PPM are tolerated, although concentrations at this level are generally unpleasant and pungent. Above this concentration, irritation of the eyes, nose and throat may begin. The extent of irritation increases with increasing ammonia concentration. Eye and throat irritation is more pronounced between 100 and 400 PPM. Above 400 PPM, skin irritation is noticeable and immediate throat irritation and coughing may result. The National Institute for Occupational Safety and Health (NIOSH) has established 500 PPM as the concentration immediately dangerous to life and health (IDLH), which is defined as the concentration above which self-rescue may be difficult or impossible due to physiological effects. At concentrations between 1000 and 2500 PPM, increasing chest tightness, bronchospasm and severe eye and skin irritation occur. Delayed effects such as chemical pneumonitis and pulmonary edema may develop several hours after exposure. At concentrations above 2500 PPM, laryngeal spasm may occur, resulting in rapid asphyxia. Effects may be more pronounced at lower concentrations in children, the elderly, and persons with impaired lung function. Additional health risks associated with exposure to ammonia include severe eye irritation that may result in corneal injury and permanent vision impairment, chemical burns and blistering, and frostbite due to rapid evaporative cooling.

In addition to the great health implications and intolerable odor of ammonia, ammonia may corrode and cause stress corrosion cracking of metals such as carbon steel and brass. Therefore, improved copper removal agents and solutions that can be used to remove copper from a surface without causing adverse environmental or health hazards are desired.

The search in patent literature revealed several US patents that describe the usage of copper chelating agents for various purposes. However, none of these patents describes the usage of the chemicals used in the current invention nor they were specifically used to clean firearms. In the following section we will show some examples of these patents and published literature in an effort to describe the prior art of our invention and to clearly demonstrate the novelty of the current invention over the prior inventions.

U.S. Pat. No. 6,864,193 by Chou, et al. entitled: “Aqueous cleaning composition containing copper-specific corrosion inhibitor” teaches the use of fabricating silicon wafers by a cleaning agent containing a copper chelating agent. He stated some examples of the copper chelating agents such as oxalic acid, malonic acid, citric acid and lactic acid. None of these acids are used or described by the current invention.

U.S. Pat. No. 5,849,680 by Wong; Ching-Ping describes a method by which electronic devices are cleaned and a copper chelating agent is used belonging to N,N″-(disalicylidene)-1,2-propanediamine (DSPDA), citric acid, phosphoric acid, ethylenediaminetetraacetic acid (EDTA), acetylacetonate. None of these chemicals are used in the current invention and the field of application is quite different.

U.S. Pat. No. 4,666,683 by Brown et al. in which the inventors describe a process for removing copper from a solution containing same with a chelating agent. The process is advantageously practiced on aqueous effluents from electroless plating systems to remove copper from an aminopolycarboxylic acid chelating agent such as ethylene diaminetetraacetic acid (EDTA). The process comprises contacting an acidic solution containing copper, and optionally ferric iron ions, and the chelating agent with a water insoluble ion exchange resin having a picolylamine or a pyridyl-imidozole functionality, whereby copper is selectively retained by the resin and the chelating agent remains in solution, and then removing the solution from the resin. Although this patent utilizes a copper chelating agent, the chelating agent is EDTA, which is different from the chelating agent described by this application, the pH value of the solution is acidic <7 and the purpose of the patent is to remove the copper from acid bath used in electronics printed circuits.

U.S. Pat. No. 3,982,999 by Kharasch describes the usage of a copper chelating agent selected from the compounds consisting of 8-hydroxyquinoline, 8-mercaptoquinoline, 7-chloro-8-hydroxyquinoline, 2-methyl-oxine, 4-azo-oxine, 4-hydroxyacridine, 6-hydroxy-m-phenantholine, 3,6-benzo-oxine, 8-methoxyquinoline, 8-hydroxyquinoline-5-sulfonic acid and .alpha.,.alpha. dipyridyl. These chemicals are different from the salicylic acid diglycol amine complexing agent described in the current application.

U.S. Pat. No. 6,005,006 by Galey, et al. mentions that copper-chelating agents have been used for a long time as depigmenting agents. Indeed, these chelating agents act on the copper ions present at the active site of tyrosinase, the key enzyme in melanogenesis. For example, it has been reported that L-mimosine, which is a natural hydroxypyridinone forms very stable complexes with copper, is a good inhibitor of tyrosinase. The current patent describes a different chemical class than hydroxypyridinone to act as copper chelating agent.

U.S. Pat. No. 6,911,393 by Nosowitz, et al. describes the use of a copper complexing agents that belong to acids or salts of: citric, iminodiacetic, 2-aminoethyl phosphonic acid, aminotri(methylenephosphonic acid) 1-hydroxyethylidene-1,1-phosphonic acid and diethylenetri-aminepenta(methylenephosphonic acid), and glycine. None of these chemical compounds are used by the current invention.

The drug named Trientine hydrochloride also called N,N′-bis(2-aminoethyl)-1,2-ethanediamine dihydrochloride manufactured by Merck pharmaceutical company and having the structure NH₂(CH₂)₂NH(CH₂)₂NH(CH₂)₂NH₂.2HCl is a copper chelating agent that removes excess copper from the human body and functions in preventing some liver cancers. The structures of the described copper chelating agents are completely different from the chemical subject of the current invention.

### SUMMARY OF THE INVENTION

The present invention provides a novel agent for removing copper from a surface, a composition including the agent, and methods of forming and using the agent. While the ways in which the present invention addresses the drawbacks of known cleaning compositions and methods will be described in more detail below, in general, the present invention provides an ammonia-free agent and a solution including the agent that are environmentally safe, non-corrosive, and non-corrosive, which can be used to efficiently remove copper from a surface such as a firearm bore.

In accordance with one embodiment of the invention, an agent for removing copper from a surface is formed from a mixture of an organic acid (e.g., salicylic acid) and an amine (e.g., diglycolamine) in the presence of an inorganic base (e.g., potassium hydroxide). The combination of the acid and the amine form a copper chelating agent that is efficient at removing copper from a surface such as a firearm bore.

In accordance with another exemplary embodiment of the present invention, a copper removing composition includes a salt formed from a mixture of an acid (e.g., salicylic acid) and an amine (e.g., diglycolamine) in the presence of an inorganic base (e.g., potassium hydroxide). In accordance with various aspects of this embodiment, the composition also includes a thickening agent or a viscofier, such as sodium carboxymethylcellulose, to facilitate maintaining the composition in contact with the surface for an extended period of time. In accordance with various additional aspects of the embodiment, the solution includes a diluent or solvent such as water, propylene glycol monomethyl ether, dipropylene glycol monomethyl ether, tripropylene glycol monomethyl ether, dipropylene glycol n-propyl ether, tripropylene glycol n-propyl ether, propylene glycol n-butyl ether, dipropylene glycol n-butyl ether, tripropylene glycol n-butyl ether, dipropylene glycol dimethyl ether, fatty acids methyl esters, fatty acid amides with diglycolamine, and/or fatty acids amine salts with diglycolamine to facilitate application and/or removal of the composition to or from a surface. In accordance with additional aspects, the composition also includes antioxidants, metal deactivators, sequestering agents and/or surfactants.

In accordance with yet another embodiment of the invention, a method of removing copper from a surface includes cleaning the surface with a composition including a chelating agent derived from mixing an acid and an amine in the presence of a base. In accordance with various aspects of the exemplary embodiment, the cleaning composition includes a salt formed from a mixture of an acid (e.g., salicylic acid) and an amine (e.g., diglycolamine) in the presence of an inorganic base (e.g., potassium hydroxide). In accordance with additional aspects of this embodiment, the composition also includes a thickening agent or a viscofier, such as sodium carboxymethylcellulose, to facilitate maintaining the composition in contact with the surface for an extended period of time. In accordance with yet additional aspects of the embodiment, the composition includes a diluent or solvent such as water, propylene glycol monomethyl ether, dipropylene glycol monomethyl ether, tripropylene glycol monomethyl ether, dipropylene glycol n-propyl ether, tripropylene glycol n-propyl ether, propylene glycol n-butyl ether, dipropylene glycol n-butyl ether, tripropylene glycol n-butyl ether, dipropylene glycol dimethyl ether, fatty acids methyl esters, fatty acid amides with diglycolamine, and/or fatty acids amine salts with diglycolamine to facilitate application and/or removal of the composition to or from a surface. In accordance with additional aspects, the composition also includes antioxidants, metal deactivators, surfactants and/or sequestering agents.

In accordance with yet a further embodiment of the invention, a method of forming a composition for cleaning a surface includes mixing an acid and an amine in the presence of a base to form a copper-chelating agent. In accordance with various aspects of this embodiment, the method of forming the composition also includes adding a thickening agent or a viscofier, such as sodium carboxymethylcellulose to the mixture. In accordance with additional aspects of the embodiment, the method further includes adding a diluent or solvent such as water, propylene glycol monomethyl ether, dipropylene glycol monomethyl ether, tripropylene glycol monomethyl ether, dipropylene glycol n-propyl ether, tripropylene glycol n-propyl ether, propylene glycol n-butyl ether, dipropylene glycol n-butyl ether, tripropylene glycol n-butyl ether, dipropylene glycol dimethyl ether, fatty acids methyl esters, fatty acid amides with diglycolamine, and/or fatty acids amine salts with diglycolamine to the mixture. In accordance with additional aspects, the method includes adding one or more antioxidants, metal deactivators, surfactants and/or sequestering agents to the mixture.

### DETAILED DESCRIPTION

The present invention provides a cleaning agent and composition for the removal of copper from a surface and methods of forming and using the agent and composition. Although the agent, composition and methods described herein may be used to clean a variety of surfaces, specific embodiments are described below in connection with cleaning a bore of a firearm. Those skilled in the art will appreciate that the compositions of the present invention are not limited the specific examples provided herein.

Exemplary compositions in accordance with embodiments of the present invention are environmentally benign (i.e., non-toxic, biodegradable, contain no VOC (volatile organic compounds), contain no HAP (hazardous air pollutant), non-corrosive to most metals, non-flammable, non-explosive, ammonia free, and very efficient in various copper removal applications, such as the removal of copper fouling from firearm bores. Thus, the use of agents and compositions of the present invention are advantageous over ammonia-based copper removal compositions known in the art.

In accordance with various exemplary embodiments of the invention, an agent is formed by mixing an organic acid (e.g., salicylic acid, benzoic acid, cinnamic acid, ortho phthalic acid, terephthalic acid, and trimelitic acid) with an amine or more preferably a hydroxylamine (e.g., diglycol amine, monoethanol amine, diethanolamine, triethanolamine, N,N-diethyl hydroxyl amine (DEHA), 2-ethoxy ethyl amine, ethoxylated fatty amines or oxyyalkylated fatty amines) in the presence of a base (e.g., potassium hydroxide, sodium hydroxide, sodium carbonate, or potassium carbonate). In accordance with various aspects of this embodiment, the organic acid is present in an amount of about 1 wt % to about 70 wt %, preferably about 5 wt % to about 50 wt %, and more preferably about 10 wt % to about 35 wt %; the amine is present in an amount of about 1 wt % to about 50 wt %, preferably about 5 wt % to about 30 wt %, and more preferably about 10 wt % to about 25 wt %; the base is present in an amount of about 0.1 wt % to about 15 wt %, preferably about 1 wt % to about 10 wt %, and more preferably about 2.5 wt % to about 8 wt %; and the composition has a pH greater than about 7, preferably about 7 to about 11, more preferably about 8 to about 10.5, and even more preferably about 8.5 to about 10.5. All percentages set for herein are by weight percents of the composition, unless otherwise indicated.

In accordance with one exemplary aspect of this embodiment, a copper removing formulation is formed by mixing salicylic acid with diglycolamine in the presence of potassium hydroxide to form the structure illustrate below.

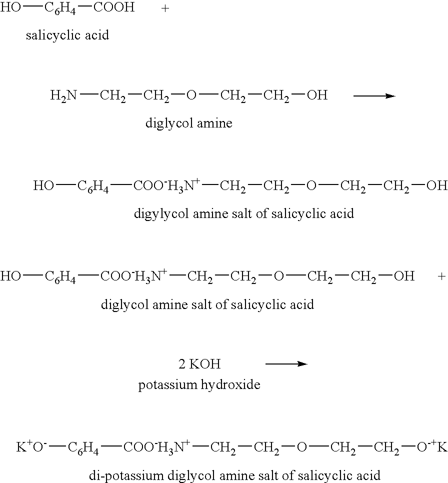

The cleaning agent can be used to remove Cu²⁺ ions, which are chelated when the electrons from the negatively charged carboxyl COO⁻ and hydroxyl O⁻ moieties are donated to the vacant orbital in the copper cation Cu²⁺.

In accordance with additional embodiments of the invention, a composition for cleaning a surface includes an agent formed by combining an organic acid with an amine in the presence of a base, as described above, and also includes one or more additional constituents, such as thickening agents, diluents, solvents, sequestering agents, surfactants, corrosion inhibitors, and the like.

In accordance with various aspects of this embodiment, the acid is present in an amount of about 1 wt % to about 70 wt %, preferably about 5 wt % to about 50 wt %, and more preferably about 10 wt % to about 35 wt %; the amine is present in an amount of about 1 wt % to about 50 wt %, preferably about 5 wt % to about 30 wt %, and more preferably about 10 wt % to about 25 wt %; the base is present in an amount of about 0.1 wt % to about 15 wt %, preferably about 1 wt % to about 10 wt %, and more preferably about 2.5 wt % to about 8 wt %; and the composition has a pH of about 7 to about 11, preferably about 8 to about 10.5, and more preferably about 8.5 to about 10.5.

In accordance with additional aspects of this embodiment, the composition includes a thickening agent or a viscofier, such as sodium carboxymethyl cellulose, alginic acid, sodium alginate, and polyamide. Exemplary compositions in accordance with this embodiment include about 0 to about 10 wt %, preferably about 0.1 wt % to about 8 wt %, and more preferably about 1 wt % to about 5 wt % thickening agent. The addition of the thickening agent increases the viscosity of the composition, which in turn aids in maintaining the composition in contact with a surface for an extended period of time. Maintaining the composition in contact with the surface for an extended period of time, in turn, facilitates that composition's ability to complex copper ions that may be on the surface and thus facilitates cleaning of the surface.

The compositions in accordance with various additional aspects may also include one or more solvents or diluents. The solvents or diluents are desirably rinsable and exhibit a relatively low vapor pressure. Exemplary diluents and solvents suitable for various compositions of the present invention include water, propylene glycol monomethyl ether, dipropylene glycol monomethyl ether, tripropylene glycol monomethyl ether, dipropylene glycol n-propyl ether, tripropylene glycol n-propyl ether, propylene glycol n-butyl ether, dipropylene glycol n-butyl ether, tripropylene glycol n-butyl ether, dipropylene glycol dimethyl ether, fatty acids methyl esters, fatty acid amides with diglycolamine, and/or fatty acids amine salts with diglycolamine. Compositions of the present invention include about 0 to about 50 wt %, preferably about 1 wt % to about 40 wt %, and more preferably about 5 wt % to about 40 wt % solvent.

Compositions of the present invention may also include additional sequestering agents, such as ethylenediamine tetracetic acid trisodium salt, ethylenediamine tetracetic acid tetrasodium salt, and sodium glycolate to complex with other ions. Inclusion of sequestering agents facilitates removal of calcium and magnesium ions, which may be present in the water used to prepare the formulation. Exemplary compositions of the present invention include about 0 to about 5 wt %, preferably about 0.1 wt % to about 2 wt %, and more preferably about 0.1 wt % to about 1 wt % sequestering agent.

In accordance with yet further exemplary aspects of the invention, the composition may include one or more surfactants such as alcohol ethoxylates. The surfactants may facilitate cleaning of the surface and allow the composition to be applied to the surface in the form of a foam. Exemplary compositions of the present invention include about 0 to about 10 wt %, preferably about 0.1 wt % to about 8 wt %, and more preferably about 1 wt % to about 5 wt % surfactant.

In accordance with further aspects, the composition includes silicates such as sodium metasilicate and potassium metasilicate to mitigate corrosion of, for example, aluminum surfaces. Exemplary compositions of the present invention include about 0 to about 5 wt %, preferably about 0.1 wt % to about 2 wt %, and more preferably about 0.1 wt % to about 1 wt % silicates.

The following non-limiting examples illustrate specific exemplary compositions in accordance with various embodiments of the invention. These examples are merely illustrative, and it is not intended that the invention be limited to these examples. Compositions in accordance with the present invention may include the ingredients listed below as well as additional and/or alternative inert materials, surfactants, and other constituents typically found in compositions for cleaning.

### Example 1

The composition of Example 1 was formed by mixing together about 18.34% salicylic acid, about 1.33% potassium hydroxide, about 13.94% diglycol amine, and about 66.39% water The pH of the composition was about 10.

The copper removal rate of the mixture was measured by soaking fifteen accurately weighed (to the nearest mg) 12 mm diameter by 17 mm length bullet slugs in the solution for about 17 hours. Similarly, fifteen accurately weighed (to the nearest mg) 12 mm diameter by 17 mm length bullet slugs were soaked for about 17 hours in a commercial ammonia based copper remover. After the 17 hour period, the bullets were rinsed with tap water, followed by deionized water, dried, and weighed. The average weight loss of the bullets was calculated for each group. The average weight loss for the slugs soaked in the formula of Example 1 removed 2.33 mg copper, whereas, the ammonia based commercial sample removed an average of 1.53 mg copper. The formula of Example 1 thus showed 35.62% increase in copper removal efficiency compared to the commercial ammonia based formula.

### Example 2

A composition according to Example 2 was formed by mixing together about 16.97% salicylic acid, about 7.17% potassium hydroxide (40% by weight solution in water), about 12.89% diglycol amine, and about 62.43% water. The pH value of the composition was about 10.24.

The removal rate of the composition of Example 2 was measured by weighing a bullet slug to the nearest 0.01 mg, submerging the slug in a test tube filled with about 20 ml of the composition of this Example 2, capping the tube, maintaining the temperature of the solution at about 25° C., and, after about 72 hours, removing the slug, rinsing the slug with water, rinsing the slug with absolute alcohol, drying the slug in hot air for about five minutes, allowing the slug to cool to room temperature, and weighing the slug. The amount of copper removed from the slug was about 5.6 mg.

### Example 3

A composition according to Example 3 was formed by mixing together about 16.97% salicylic acid, about 7.17% potassium hydroxide, about 12.89% diglycol amine, about 1.49% sodium carboxymethyl cellulose (viscosity range about 200-400 cp at 25° C.), and about 62.43% water. The pH value of the composition was about 10.24.

The removal rate of the composition of Example 3 was measured by weighing a bullet slug to the nearest 0.01 mg, submerging the slug in a test tube filled with about 20 ml of the composition of this Example 3, capping the tube, maintaining the temperature of the solution at about 25° C., and, after about 72 hours, removing the slug, rinsing the slug with water, rinsing the slug with absolute alcohol, drying the slug in hot air for about five minutes allowing the slug to cool to room temperature, and weighing the slug. The copper removed from the slug was about 9.61 mg, which was higher than that of a commercial ammonia based copper removing agent.

The present invention sets forth an exemplary copper removal agent and a composition that are relatively non-toxic, biodegradable, non-corrosive to most metals, non-explosive, non-flammable, and have minimal or no VOC (volatile organic compounds)and HAP (hazardous air pollutants). It will be understood that the foregoing description is of exemplary embodiments of the invention, and that the invention is not limited to the specific agents and formulations shown. Various modifications may be made in the actual compositions and processing steps set forth herein without departing from the scope of the invention, which is set forth in the following claims and their equivalents. These and other changes or modifications are intended to be included within the scope of the present invention.

1. An agent for removing copper from a surface, the agent comprising:
a compound formed from a combination of an organic acid, an amine, and a base, wherein the composition comprises an organic carboxylic acid derivative, including a COOH group; and
a hydroxylamine derivative, including an OH group,
wherein the organic carboxylic acid derivative ionizes to form a COO— group and the hydroxylamine derivative ionizes to form an O— group, which function together to chelate copper ions in a solution.

2. The agent for removing copper from a surface of claim 1, wherein the organic acid is selected from the group consisting of salicylic acid, benzoic acid, cinnamic acid, ortho phthalic acid, terephthalic acid, and trimelitic acid.

3. The agent for removing copper from a surface of claim 2, wherein the organic acid is salicylic acid.

4. The agent for removing copper from a surface of claim 1, wherein the amine is a hydroxylamine selected from the group consisting of diglycol amine, monoethanol amine, diethanolamine, triethanolamine, N,N-diethyl hydroxylamine, 2-ethoxy ethyl amine, ethoxylated fatty amines and oxyalkylated fatty amines.

5. The agent for removing copper from a surface of claim 4, wherein the amine is diglycol amine.

6. The agent for removing copper from a surface of claim 1, wherein the base is selected from the group consisting of potassium hydroxide, sodium hydroxide, sodium carbonate, and potassium carbonate.

7. The agent for removing copper from a surface of claim 6, wherein the base is potassium hydroxide.

8. The agent for removing copper from a surface of claim 1, wherein the organic acid is present in an amount of about 1 wt % to about 70 wt %.

9. The agent for removing copper from a surface of claim 1, wherein the amine is present in an amount of about 1 wt % to about 50 wt %.

10. The agent for removing copper from a surface of claim 1, wherein the base is present in an amount of about 0.1 wt % to about 15 wt %.

11. A cleaning composition for removing copper from a surface, the composition comprising:
a compound formed from a combination of an organic acid, an amine, and a base, wherein the compound comprises an organic acid derivative, including a COOH group and an amine derivative, including an OH group, wherein the COOH group ionizes to form a carboxyl COO— group and the OH group ionizes to form an O— group, which function together to chelate copper ions in a solution.; and a diluent.

12. The cleaning composition for removing copper from a surface of claim 11, wherein the composition comprises:
about 1 wt % to about 70 wt % organic acid;
about 1 wt % to about 50 wt % amine;
about 0.1 wt % to about 15 wt % base; and
about 1 wt % to about 40 wt % diluent

13. The cleaning composition for removing copper from a surface of claim 11, further comprising a sequestering agent.

14. The cleaning composition for removing copper from a surface of claim 13, wherein the sequestering agent comprises a compound selected from the group consisting of ethylenediamine tetracetic acid trisodium salt, ethylenediamine tetracetic acid tetrasodium salt, and sodium glycolate.

15. The cleaning composition for removing copper from a surface of claim 11, further comprising a surfactant.

16. The cleaning composition for removing copper from a surface of claim 15, wherein the surfactant comprises an alcohol ethoxylate, alcohol sulfate, alcohol sulfonate or nonylphenol ethoxylate.

17. The cleaning composition for removing copper from a surface of claim 11, further comprising a thickening agent.

18. The cleaning composition for removing copper from a surface of claim 17, wherein the thickening agent comprises a compound selected from the group consisting of sodium carboxymethyl cellulose, alginic acid, sodium alginate, and polyamide.

19. The cleaning composition for removing copper from a surface of claim 11, further comprising a corrosion inhibitor.

20. The cleaning composition for removing copper from a surface of claim 11, further comprising a metal deactivator.

21. The cleaning composition for removing copper from a surface of claim 11, wherein the pH of the composition is greater than about 7.

22-27. (canceled)

28. A method of forming a composition for removing copper from a surface, the method comprising the steps of:
providing an organic carboxylic acid;
providing an amine;
providing a base; and
mixing together the organic carboxylic acid, the amine, and the base to form a compound having an organic acid derivative including a COOH group and an amine derivative, including an OH group, wherein the COOH group ionizes to form COO— and the OH group ionizes to form an O— group, which function together to chelate copper ions.
